(19) United States
(12) Patent Application Publication
(10) Pub. No.: US 2009/0211026 A1
(43) Pub. Date: Aug. 27, 2009

(54) MEDICAL TRANSPORT SAFETY APPARATUS WITH LIGHTING SYSTEM

(76) Inventor: ROBERT SCHOFF, Brookfield, IL (US)

Correspondence Address: LAMPEL & ASSOCIATES, P.C., 555 SKOKIE BLVD., SUITE 500, NORTHBROOK, IL, 60062, US

(21) Appl. No.: 12/037,184

(22) Filed: Feb. 26, 2008

(51) Int. Cl. A61G 7/00

(52) U.S. Cl. 5/600

(57) ABSTRACT

The present invention generally relates to an apparatus, such as a stretcher or gurney, which may be used to transport an injured person is a safe and efficient manner. The apparatus is especially suitable for safely transporting injured persons in, for example, dimly lit areas. More specifically, the apparatus has adjustable lights which may illuminate both a patient and the ground during movement of the apparatus. The lighting system also has a battery source which recharges when the apparatus is electrically connected to a docking station located within an ambulance, hospital or other suitable place. The apparatus may increase the effectiveness of medical treatment by allowing EMS specialists or paramedics or other persons to effectively and quickly provide medical care to an injured patient. Further, the apparatus allows the user to have two hands free to carry and/or control the stretcher, gurney or the like as a result of the user not having to carry a hand-held flashlight.

### BACKGROUND OF THE INVENTION

The present invention generally relates to an apparatus, such as a stretcher or gurney, which may be used to transport an injured person is a safe and efficient manner. The apparatus is especially suitable for safely transporting injured persons in, for example, dimly lit areas. More specifically, the apparatus has adjustable lights which may illuminate both a patient and the ground during movement of the apparatus. The lighting system also has a battery source which recharges when the apparatus is electrically connected to a docking station located within an ambulance, hospital or other suitable place. The apparatus may increase the effectiveness of medical treatment by allowing paramedics or other persons to effectively and quickly provide medical care to an injured patient. Further, the apparatus allows the user to have two hands free to carry and/or control the stretcher, gurney or the like as a result of the user not having to carry a flashlight.

U.S. Pat. No. 7,047,578 to Spanton discloses an apparatus such as a stretcher or gurney, and method, for engaging acquiring and transporting an injured person or some other person or object. The apparatus comprises a base, housing or frame having a low clearance portion; a first conveyance assembly movably connected to the housing for moving the housing with respect to the ground or another base surface; a second conveyance assembly movably connected to the housing for moving the person or object with respect to the housing; and a power member for moving the first and second conveyance assemblies. The apparatus is liftable by other persons to transport the person or object to another location. The method comprises the steps of moving a housing having a low clearance portion so that the low clearance portion moves toward and under the person or object; and moving the person or object relative to the housing. The device and method are mechanized and substantially automated. The device moves so that the person or object remains stationary during loading.

U.S. Pat. No. 6,658,680 to Osborne et al discloses a bed for a person. The bed includes a frame, a deck, a mattress, a pair of head end siderails, and a pair of foot end siderails. The bed further includes a controller configured to be coupled to the head and foot end siderails.

U.S. Pat. No. 5,749,374 to Schneider discloses a pneumatic conveying system for conveying particulate material through a conduit that creates a strong laminar flow of materials and air surrounded by a boundary layer flow of air, such that long transport distances through dramatic elevation and directional changes can be achieved. Embodiments of the system include a blower assembly, an inlet conduit, an outlet conduit and a mixing chamber, wherein the mixing chamber includes an outer barrel, an inner barrel and an accelerating chamber. Low pressure air is supplied to the system by the blower assembly and mixed with particulate material. The air/material mixture is transported through the mixing chamber into the accelerating chamber and through the outlet conduit. In other preferred embodiments, the particulate material is mixed with the air in the accelerating chamber.

U.S. Pat. No. 5,494,051 to Schneider discloses a litter for the transportation of a patient from the field to a hospital. The litter has devices for monitoring and responding to the condition of the patient, including blood pressure, temperature, blood oxygen, and heart rate. At least one device for assisting the patient's breathing and for stabilizing the heart are provided with the litter. Electronic equipment provided with the litter includes a central processing unit and a visual display to permit emergency personnel to maintain a close watch on the patient's condition, and for real-time communication with hospital personnel. The litter has provisions for connection with external air and electrical power, and has lights for operation under conditions of reduced illumination.

However, these patents fail to provide an apparatus as disclosed by the present invention. More specifically, these patents fails to disclose a gurney or stretcher having a unique lighting system wherein the lighting system illuminates a patient and the surrounding area of the ground when the apparatus is moving. The present invention also provides safe footing for emergency medical service (EMS) personal during the transportation of an individual on the gurney or stretcher. A need, therefore, exists for an improved apparatus for providing a safe and efficient manner in which to transport a patient.

### SUMMARY OF THE INVENTION

The present invention generally relates to an apparatus, such as a stretcher or gurney, which may be used to transport an injured person is a safe and efficient manner. The apparatus is especially suitable for safely transporting injured persons in, for example, dimly lit areas. More specifically, the apparatus has adjustable lights which may illuminate both a patient and the ground during movement of the apparatus. The lighting system also has a battery source which recharges when the apparatus is electrically connected to a docking station located within an ambulance, hospital or other suitable place. The apparatus may increase the effectiveness of medical treatment by allowing EMS provider or paramedics or other persons to effectively and quickly provide medical care to an injured patient. Further, the apparatus allows the user to have two hands free to carry and/or control the stretcher, gurney or the like as a result of the user not having to carry a flashlight. Further, the apparatus allows the user to have two hands free to provide medical assistance to the individual being transported.

An advantage of the present invention is to provide an apparatus, such as a gurney or stretcher, which has an illumination system for illuminating a patient.

An advantage of the present invention is to provide an apparatus, such as a gurney or stretcher, which has an illumination system for illuminating the ground around the apparatus while the apparatus is being used to transport a patient.

Another advantage of the present invention is to provide an apparatus, such as a gurney or stretcher, which is light weight and durable.

And an advantage of the present invention is to increase the safety of the user by allowing the user to utilize both hands to control the stretcher, gurney or the like as a result of the user not having to carry a hand-held flashlight.

A further advantage of the present invention is to allow the user to have safe footing in controlling the stretcher, gurney of the like.

A further advantage of the present invention is to provide an apparatus, such as a gurney or stretcher, which has a rechargeable power source.

A still further advantage of the present invention is to provide an apparatus, such as a gurney or stretcher, which is electrically connected to a power-supplying docking station while the apparatus is in an ambulance, hospital or the like.

For a more complete understanding of the above listed features and advantages of the invention, reference should be made to the following detailed description of the preferred embodiments and to the accompanying drawings. Further, additional features and advantages of the present invention are described in, and will be apparent from, the detailed description of the preferred embodiments and from the drawings.

### BRIEF DESCRIPTION OF THE DRAWINGS

FIG. 1 illustrates a side perspective view of the apparatus wherein an individual is being transported.

FIG. 2 illustrates a side perspective view of the apparatus wherein the apparatus is being inserted into an emergency vehicle and wherein the electrical connection between the apparatus and the emergency vehicle is displayed.

FIG. 3 illustrates a side flat view of the apparatus.

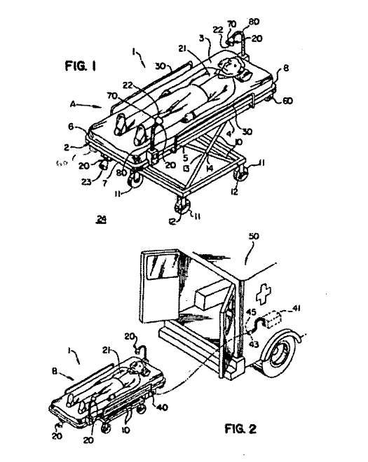

### DETAILED DESCRIPTION OF THE PREFERRED EMBODIMENTS

The present invention generally relates to an apparatus, such as a stretcher or gurney, which may be used to transport an injured person is a safe and efficient manner. The apparatus is especially suitable for safely transporting injured persons in, for example, dimly lit areas. More specifically, the apparatus has adjustable lights which may illuminate both a patient and the ground during movement of the apparatus. The lighting system also has a battery source which recharges when the apparatus is electrically connected to a docking station located within an ambulance, hospital or other suitable place. The apparatus may increase the effectiveness of medical treatment by allowing paramedics or other persons to effectively and quickly provide medical care to an injured patient. Further, the apparatus allows the user to have two hands free to carry and/or control the stretcher, gurney or the like as a result of the user not having to carry a flashlight.

The present invention generally relates to an apparatus 1, such as a stretcher or gurney, which may be used to transport, for example, an injured person in a safe and efficient manner. The apparatus 1 has a frame 2 which may be constructed from, for example, metal which may be strong and durable. The frame 2 may have a top surface 3, a bottom surface 4, a first side 5, a second side 6, a front 7 and a back 8. Example embodiments of the current apparatus 1 are illustrated herein.

The apparatus 1 may further have four legs 10 which may be attached to the under-side of the frame 2. Each leg 10 may have a wheel 11 having a locking mechanism 12. The four legs 10 are preferably attached near the four corners of the frame 2 such that stability of the apparatus 1 and any weight the apparatus 1 is carrying is maximized. The legs 10 attach to the front 7 of the apparatus 1 may cross the legs 10 attached to the back 8 of the apparatus 1 at a midpoint 13 of the legs 10. A pin 14 may secure the front legs 10 to the back legs 10 for additional stability. The legs 10 of the apparatus 1 may be extended fully in a first position A to allow an EMS specialist or paramedic or other individual to roll the apparatus 1 on the ground. Alternatively, the apparatus 1 may be carried in a second position B, wherein the paramedic or other individuals carry the apparatus 1 and support the weight of the apparatus 1 and any person and/or object located on top of the apparatus 1.

If the legs 10 of the apparatus 1 are extended and used to support the weight of the apparatus 1 and/or any person and/or object on the apparatus 1, the legs 10 of the apparatus 1 may fold from the first position A into the second position B while the apparatus 1 is being placed into an ambulance. In the second position B, the legs 10 of the apparatus 1 may be folded upward toward the bottom surface 4 of the apparatus 1 such that the total height of the apparatus 1 is dramatically reduced. The apparatus 1 is then commonly transported in an ambulance in this second position B.

The apparatus 1 may have a lighting system 20 for safely and effectively transporting a patient. The lighting system 20 may include a light source 22 directed at, for example, a patient 21 and/or a light source 23 directed at, for example, the ground 24. The lighting system 20 is particularly useful in directing the light source 23 at the ground 24 when, for example, the apparatus 1 is being used to transport an individual. As a result of the lighting system 20, an EMS specialist or a paramedic or other care giver may be able to view the patient 21 and discover injuries or other information which may be needed to help in the treatment of the patient 21. Current gurneys or stretchers lack a lighting system which illuminates a patient while the patient is on the gurney. As a result, the paramedic or other care giver may fail to notice a problem with the patient until the patient is transported and secured into the ambulance or the hospital. As a result, current gurneys or stretchers can delay the discovery of injuries or other problems and, therefore, the medical help given may be diminished.

The apparatus 1 may have a handles 30 located on, for example, the first side 5 of the apparatus 1 and the second side 6 of the apparatus 1. The handles 30 may help the paramedics or other users to transport the apparatus 1 in an expedited manner. Alternatively to, or in addition to, the handles 30 are located at the front 7 and the back 8 of the apparatus 1. Preferably, the handles 30 are made from the same durable material as the frame 2 of the apparatus 1. Although the handles 30 may be of varying length, the handles 30 are preferably at least one-third the length of the apparatus 1 so that the paramedics transporting the injured person and the apparatus 1 may be able to grasp the handles 30 at the best possible location on the apparatus 1. In addition, the handles 30 of the apparatus 1 may help prevent the individual being transported from inadvertently falling off the apparatus 1.

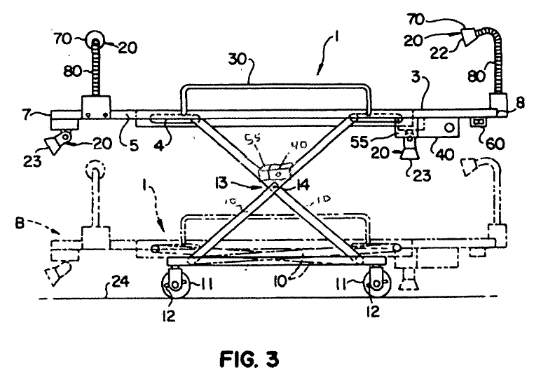

The lighting system 20 may have an onboard rechargeable battery system 40. The onboard rechargeable battery system 40 may be located, for example, near the bottom surface 4 of the apparatus 1. More specifically, the onboard rechargeable battery system 40 may be secured to the under-side of the frame 2 of the apparatus 1. Alternatively, the onboard rechargeable battery system 40 may be located on, for example, one of the legs 10 of the apparatus 1 (See FIG. 3). The onboard rechargeable battery system 40 may include a rechargeable battery pack 55. While the apparatus 1 is located inside the ambulance 50, the onboard rechargeable battery system 40 may be electrically connected to a docking station 41 for recharging. More specifically, the onboard rechargeable battery system 40 may be electrically connected to the docking station 41 by, for example, an electrical cord (as described below) or a hard docking without a cord. FIG. 2 illustrates a cord being used to electrically connect the onboard rechargeable battery system 40 to the docking station 41. The docking station 41 may be permanently secured into the ambulance 50. The battery pack 55 may be similar to other known battery packs and may store power for the lighting system 20 while the apparatus 1 is not attached to the docking station 41.

The lighting system 20 may be used while the apparatus 1 is being moved, such as in the transportation of a patient. As a result, the paramedics or other individuals moving the apparatus 1 may have an illuminated view of the ground 24 and, therefore, may avoid accidentally bumping the apparatus 1 into an unseen object. The lighting system 20 may be controlled by a light switch 60 located, for example, near the front 7 and/or rear of the apparatus 1. A user may manually control the lighting system 20 by switching the light switch 60 between an “ON” and “OFF” position. The light switch 60 may be electrically connected to a plurality of lights 70 by electrical wire 71. Further, the lighting system 20 may electrically connect the plurality of lights 70 to the onboard rechargeable battery system 40 by electrical wire 71. More specifically, the onboard rechargeable battery system 40 may provide the power source for illuminating the plurality of lights 70 of the lighting system 20.

While the apparatus 1 is docketed into the corresponding docking station 41 the rechargeable battery 55 of the apparatus 1 may pull and store power from the docking station 41. As stated above, the docking station 41 may be located in, for example, an ambulance 50, a hospital or any other suitable location.

The rechargeable battery 55 may electrically connect to the docking station 41 by, for example, connecting an exposed electrical connection 43 on the apparatus 1 to an exposed electrical connection 43 of the docking station 41. The exposed electrical connection 43 of the apparatus 1 and the docking station 41 may have a safety guard 45 which prevents unintentional contact with any electrical component. The safety guard 45 may work by covering a portion of the exposed electrical connection 43 while the apparatus 1 is not connected to the docking station 41.

The lighting system 20 may illuminate, for example, the handle 30 (or general handle area) of the apparatus 1. Further, the lighting system 20 may have a light 70 which extends upward from the top surface 3 of the apparatus 1 which illuminates the patient 100. The plurality of lights 70 on the lighting system 20 may be on a flexible arm 80 which may allow the EMS specialist or the paramedic to adjust the direction of the light 71. The lights 70 of the lighting system 20 may be, for example, high intensity LED lights.

As stated above, the lighting system 20 may also illuminate the ground near the apparatus 1. More specifically, the user may shift the light switch 60 into the “ON” position in order to turn on the plurality of lights 70 which illuminate the ground 24. Although the plurality of lights 70 may be turned on in any environment, illuminating the ground 24 in a dark environment may be especially useful. Often paramedics are forced to quickly place an injured person onto a gurney and carry the person away to safety and for medical treatment. Further, it is common for the injured person to be located in an environment with diminished light such as, for example, a night car accident or a building after power has been lost. As a result, the paramedic may provide full attention to the patient instead of having to either hold a flashlight or instead of being distracted trying to navigate a dark environment.

Although embodiments of the present invention are shown and described therein, it should be understood that various changes and modifications to the presently preferred embodiments will be apparent to those skilled in the art. Such changes and modifications may be made without departing from the spirit and scope of the present invention and without diminishing its attendant advantages. It is, therefore, intended that such changes and modifications be covered by the appended claims.

1. An apparatus for carrying a person comprising:
a frame having a first side, a second side, a front, a back, a top surface and a bottom surface;
a first light source wherein the light source directs a light beam onto the top surface of the apparatus and wherein the first light source is located on a flexible arm;
a second light source wherein the second light source directs a second light beam toward the ground and wherein the second light source directs the second light beam while the apparatus is moving and wherein the second light source is located on a flexible arm; and
a rechargeable battery system wherein the rechargeable battery system powers the first light source and second light source and wherein the rechargeable battery system docks with a corresponding docking station located off the frame of the apparatus and wherein the corresponding docking station supplies power to the rechargeable battery system and wherein a safety guard aligns the rechargeable battery system with the corresponding docking system.

2. (canceled)

3. (canceled)
